(19) United States
(12) Patent Application Publication
(10) Pub. No.: US 2002/0119750 A1
(43) Pub. Date: Aug. 29, 2002

(54) Geosynchronous satellites

(75) Inventor: Thierry Youssefi, Labastidette (FR)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/975,996

(22) Filed: Oct. 15, 2001

(30) Foreign Application Priority Data
Oct. 16, 2000 (FR) 0013211

(51) Int. Cl. H04Q 7/20

(52) U.S. Cl. 455/12.1; 455/427; 455/13.3

(57) ABSTRACT

The invention relates to a geosynchronous satellite including antenna means for communicating with an area (34) of the terrestrial surface.

The satellite includes attitude control means whereby North (24) and South (26) walls of the satellite are at all times parallel to the solar radiation (28), and adjustment means so that the antenna means are always pointed toward the terrestrial coverage area.

The satellite includes a support (32) for all the antenna means that can be oriented relative to the body (22) of the satellite including the North and South walls, for example.

The invention relates to a geosynchronous satellite including antennas facing toward the Earth for communicating with terrestrial equipment.

A geosynchronous satellite, i.e. a satellite whose position relative to the Earth is fixed, is at a distance of 36 000 km from the Earth and can therefore cover a vast region of the Earth. This is why geosynchronous satellites are often used to relay communications of all kinds: telephony, television, etc.

The increasing requirement for communication leads to the requirement to increase the power of the equipment on board geosynchronous satellites.

The equipment includes, firstly, that necessary to the mission of the satellite, in other words, generally speaking, telecommunication equipment: multiplexers, power amplifiers, etc., and the send and receive antennas directed toward the Earth. The equipment also includes means for maintaining and/or controlling the attitude of the satellite in the necessary position and heat exchangers for evacuating heat produced by some of the equipment or received from the Sun. The electrical power for the equipment is supplied, on the one hand, by solar power generators consisting of solar panels and, on the other hand, by electrical power storage batteries enabling the mission of the satellite to continue when it is in an eclipse area.

The power of the equipment of a satellite is usually increased by increasing the size or the number of solar panels, which increases the size of the heat exchangers for evacuating heat; in other words, the overall size and the mass of the satellite are increased. However, increasing the size and the mass of the satellite leads to problems with the mechanical strength of the satellite and problems of cost, since fewer satellites can be carried by the same launcher.

To increase the total power radiated by the heat-dissipating heat exchangers without increasing the total outside surface area of the satellite, and thereby its overall size and its mass, a satellite has been proposed incorporating heat exchangers that can be deployed, i.e. that do not cover the outside surface of the satellite but are connected to the satellite by a fluid loop ensuring good thermal conductivity. However, in order for them not to mask the field of view of the antennas significantly, the deployable heat exchangers are at an angle of the order of 20° to the North and South walls, of which they constitute an extension, which reduces their efficiency because those walls are directly exposed to solar radiation.

However the satellite is implemented, its North and South walls, which are the walls least exposed to solar radiation, are covered with heat exchangers consisting of quartz reflectors (OSR) which evacuate heat by infrared radiation, and the electronic equipment dissipating heat is located under those walls. However, the quartz reflectors are progressively degraded by the thermal stresses to which they are constantly exposed, which reduces their efficiency and consequently the service life of the satellite.

The invention provides a geosynchronous satellite which, for the same mass, offers significantly higher equipment power than prior art geosynchronous satellites.

To this end, the geosynchronous satellite according to the invention has North and South walls parallel to the solar radiation at all times, and includes means so that the antenna means are always pointed toward the terrestrial coverage area.

The orientation of the North and South walls of the body of the satellite minimizes the effect of solar radiation. Thus, in one embodiment, the North and South walls do not carry quartz reflectors (OSR) but, instead, have a simple reflective coating, such as a coat of white paint. This reduces the cost and mass of the satellite and the time to build it.

In one embodiment, the antenna means are fastened to a wall that is mobile relative to the body of the satellite to enable the antenna means to be pointed toward their coverage area at all times.

Because, in the preferred embodiment of the invention, the orientation of the body of the satellite relative to the solar radiation is constant, the solar panels can be oriented so that they are always perpendicular to that radiation.

In this case, it can be shown that, for the same panel surface area, the power of the solar generator is 9% greater than the power of a conventional satellite, and this is achieved without increasing the mass or the overall size of the satellite.

Furthermore, calculation shows that, because the body of the satellite is oriented with the North and South walls in the direction of the solar radiation, the power that can be dissipated is 53% higher than could be achieved without this feature, which is reflected in a 53% increase in the capacity of the satellite.

The orientable panel including the antenna means can be manufactured separately from the remainder of the satellite. It is therefore possible to manufacture the panel with the antenna means and the remainder of the satellite simultaneously and assemble them afterwards. This reduces the time to manufacture the satellite as a whole.

Thus the invention also provides a method of manufacturing a geosynchronous satellite which is characterized in that the satellite has a body whose North and South walls can be oriented in the direction of solar radiation and a support for antenna means that can be oriented relative to the body so that the antennas are always pointed toward the terrestrial area with which they must communicate, in which method the support and the antenna means are constructed separately from the remainder of the satellite and the support and the body of the satellite are assembled afterwards.

In one embodiment, the antenna reflectors are fixed near the sources, the connection between the sources and the reflectors being effected by means of arms, preferably made of carbon for good thermo-elastic stability. The direct connection of the reflectors near the sources by means of carbon arms with a virtually zero coefficient of thermal expansion eliminates the effects, as encountered in conventional implementations, of thermo-elastic deformation of the casing of the satellite.

In one embodiment, the antennas are of the electronically scanned type; compared to the first embodiment, this avoids the necessity to provide a panel that can be oriented relative to the remainder of the body of the satellite.

Because the body of the satellite always has the same attitude relative to the solar radiation, the equipment, and in particular the electronic equipment under the North and South walls, is exposed to only small temperature variations. This increases reliability and makes the qualification criteria for the components less severe, thermal tests and analyses being simplified in particular.

In one embodiment, the means for orienting the antennas are used to correct pointing errors or to modify the terrestrial coverage area.

In one embodiment, the output multiplexer is on the outside face of the North/South heat exchangers, which represents a space saving in the internal area for installing equipment and an increase in the capacity of the platform. Because the output multiplexers are very hot (100 to 180° C.), eliminating the 23° inclination of the North/South heat exchangers means that, with appropriate protection (baffles), they can be exposed directly to space to provide radiant thermal control of the body of the multiplexer, which is at 180° C. and radiates heat directly into space at 4° K.

When the antenna means are on a support that can be oriented relative to the remainder of the body of the satellite, a connection by means of a flexible guide must be provided between the support and the control electronics in the body. However, connections of this kind are already known in the art, for example as used in Alcatel's SPOT Mobile antenna for the SESAT satellite. That antenna, motorized with +/−20° relative movement about two axes, has proven flexible waveguides under conditions similar to the requirements of the present invention.

In brief, the invention provides a geosynchronous satellite including antenna means for communicating with an area of the terrestrial surface, attitude control means whereby North and South walls of the satellite are at all times parallel to the solar radiation, and adjustment means so that the antenna means are always pointed toward the terrestrial coverage area.

One embodiment of the satellite includes solar panels perpendicular to the solar radiation whose surface is fastened to the body of the satellite.

One embodiment includes a support for all the antenna means that can be oriented relative to the body of the satellite including the North and South walls.

In this case, telecommunication electronics means are fastened to the support for the antenna means, for example, and/or the attitude control means and the support adjustment means are fastened to the body of the satellite.

In another embodiment the adjustment means for maintaining the antenna means pointed at all times toward the coverage area include electronic scanning means.

The adjustment means for maintaining the antenna means directed at all times toward the terrestrial coverage area can also be used for pointing corrections and/or to modify the position of the coverage area.

The North and/or South walls are advantageously covered with white paint.

In one embodiment output multiplexers are disposed on an outside face and preferably associated with radiant thermal control by direct exposure to space.

The antenna means include reflectors connected to the support by carbon arms, for example.

The carbon arms are generally H-shaped, for example.

The invention also provides a method of assembling a geosynchronous satellite wherein the support with the antenna means is constructed separately from the body of the satellite.

Other features and advantages of the invention will become apparent in the course of the following description of embodiments of the invention, which description is given with reference to the accompanying drawings, in which:

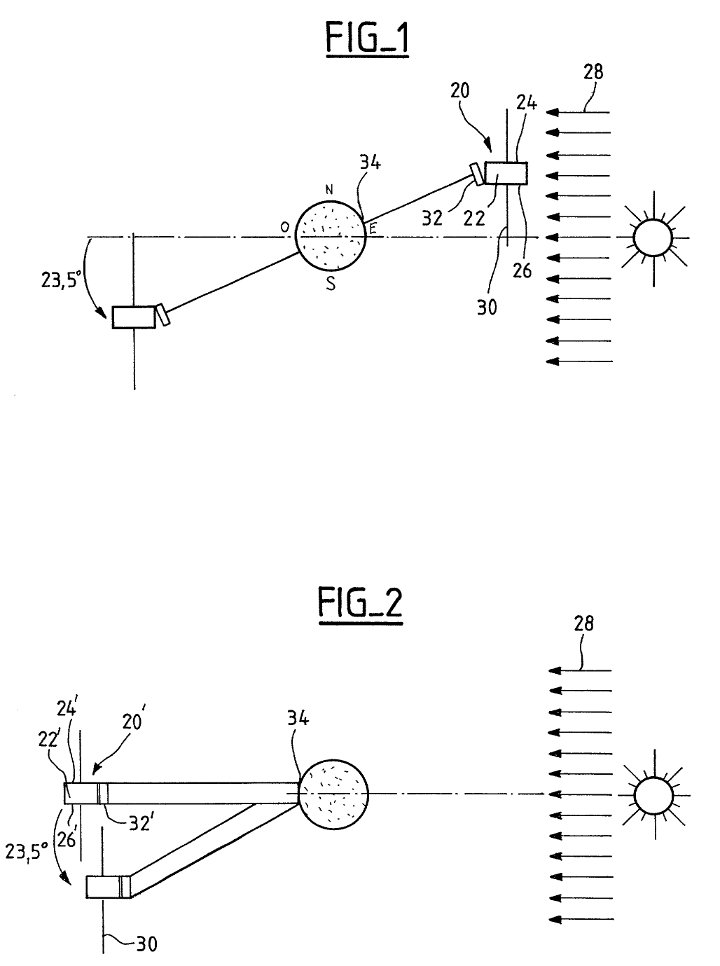

FIG. 1 is a diagram showing a first embodiment of the invention,

FIG. 2 is a diagram analogous to FIG. 1 showing a different embodiment,

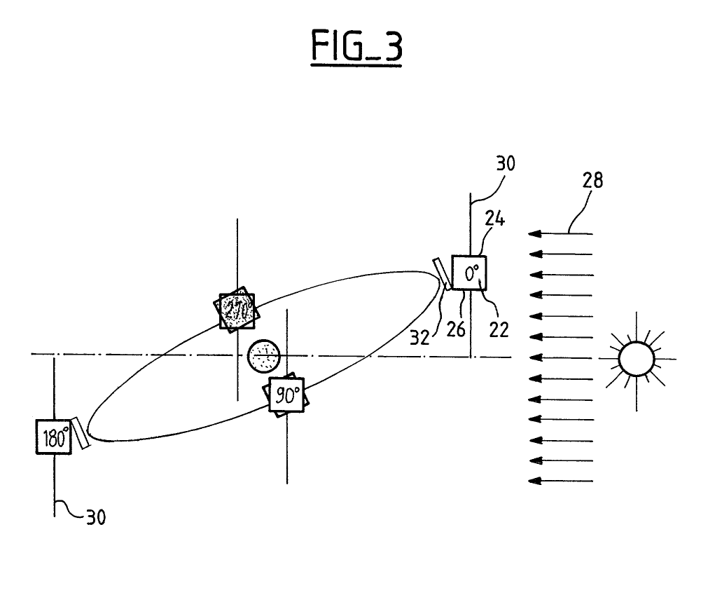

FIG. 3 is a diagram corresponding to FIG. 1 and showing various positions of the satellite according to the invention,

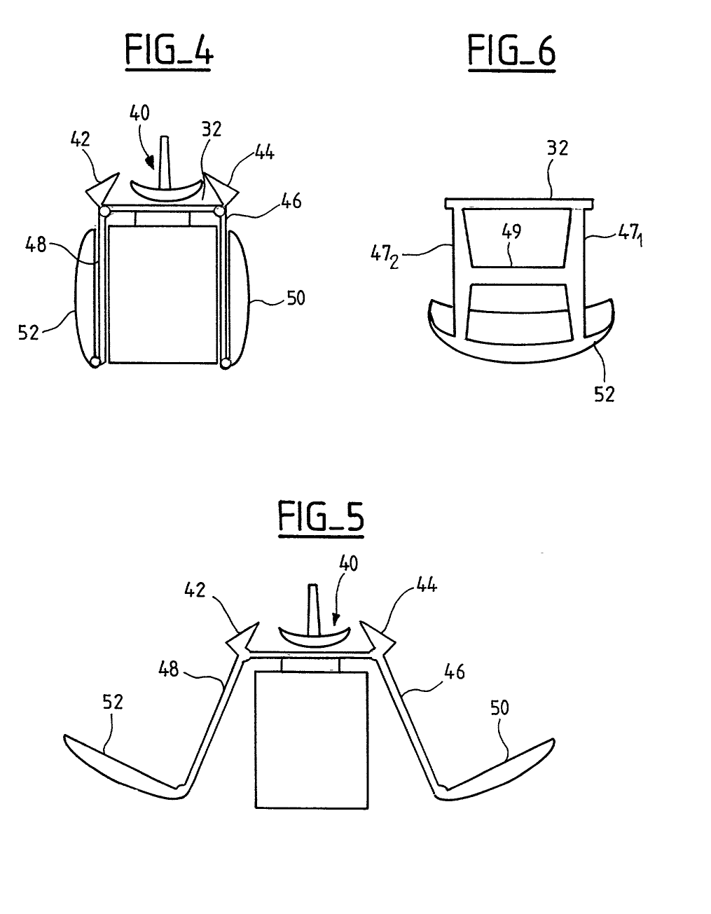

FIG. 4 shows the satellite shown in FIG. 1 in more detail in a stowed position, prior to launch,

FIG. 5 is a view analogous to FIG. 4, for the deployed position of the satellite,

FIG. 6 is a side view relative to FIG. 5,

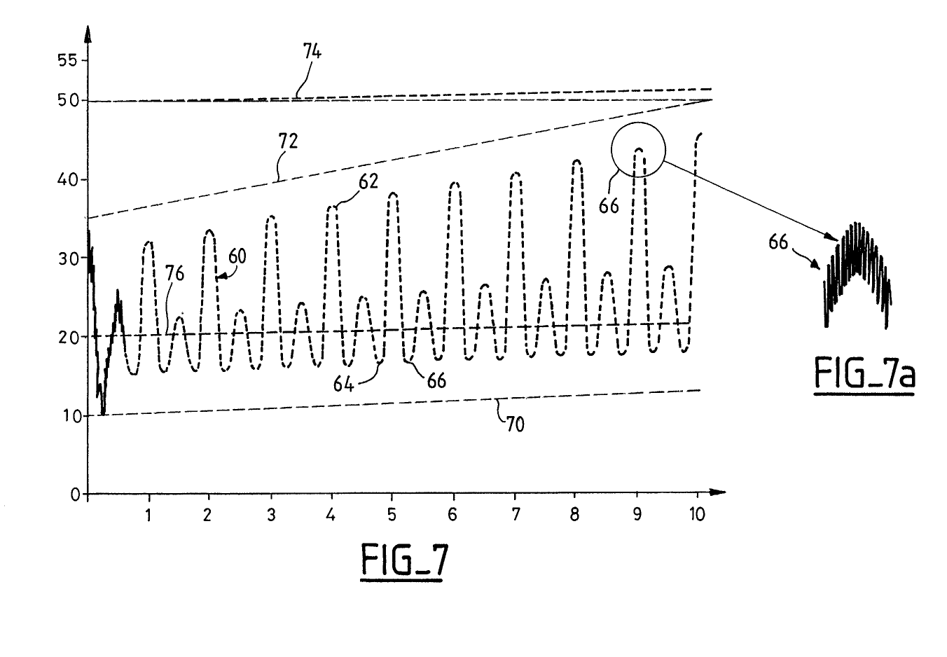

FIG. 7 is a diagram showing some properties of conventional satellites and of a satellite according to the invention,

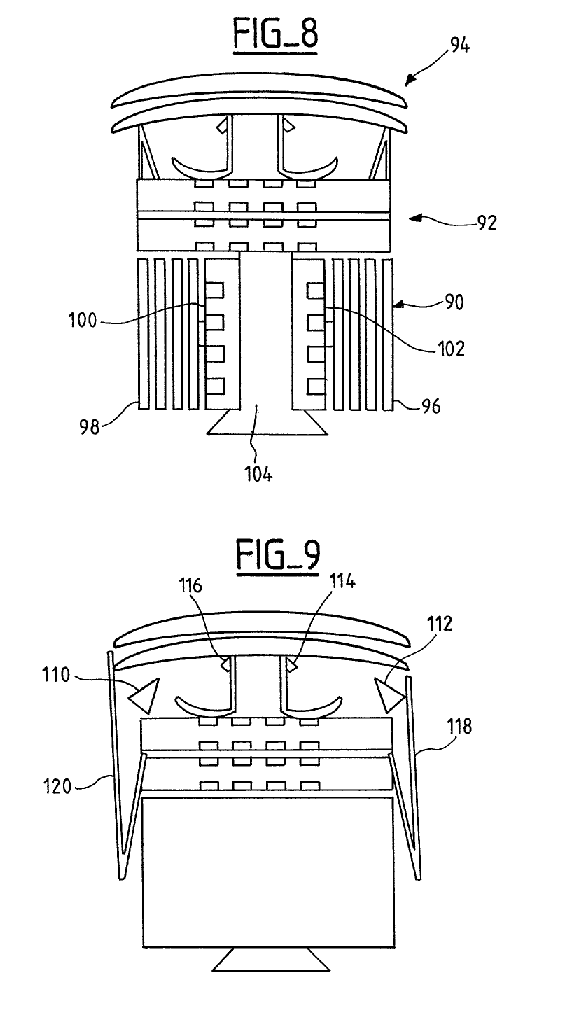

FIG. 8 is a diagram showing an embodiment of a satellite corresponding to FIG. 1 in a folded position,

FIG. 9 is a side view relative to FIG. 8.

The geosynchronous satellite and the method of manufacturing it described next with reference to the drawings can be used for a transmit and receive power from 10 to 20 kW.

A first embodiment of the geosynchronous satellite 20, shown in FIG. 1, includes a body 22 whose North and South faces 24 and 26 are always parallel to the solar flux 28 and whose solar panels 30, used to generate electrical power, are always perpendicular to the flux 28.

A support 32 for the antennas (not shown in detail in the FIG. 1 diagram) is articulated to the body 22 and control means are provided so that the antennas are always directed toward the terrestrial coverage area 34.

In the embodiment shown diagrammatically in FIG. 2, the satellite 20′ also has a body 22′ whose North and South walls 24′ and 26′ are always parallel to the solar flux 28. On the other hand, the antenna support 32′ is not mobile relative to the body 22′. This is because the antennas are of the electronically scanned type and can be pointed toward the coverage area 34 with no mechanical displacement.

FIG. 3 is a diagram showing the various attitudes of the satellite 20 shown in FIG. 1 during a 24-hour cycle. For the North and South faces 24 and 26 to be parallel to the solar flux 28 at all times, and for the solar panels 30 to be directed toward the flux 28 at all times, the satellite must have attitude control means in addition to means for controlling the orientation of the support 32.

Thus it can be seen that, in the 0° position of the satellite, the receiving face of the solar panels 30 is on the opposite side to the support 32, whereas in the 180° position the receiving face of the solar panels 30 must be on the same side as the antenna support 32.

FIG. 4 is a diagram of the embodiment of the satellite 20 shown in FIG. 1, in a stowed configuration, for example during launch, and FIG. 5 shows the satellite after launch.

A receive antenna 40 and the sources 42 and 44 of the send antenna are mounted on the support 32. Arms 46 and 48, made of carbon for example, are articulated to the support 32. Their other ends are articulated to respective send antenna reflectors 50 and 52.

The solar panels are not shown in these diagrams.

FIG. 6 is a side view relative to FIG. 4.

The arm 46 is H-shaped with two branches 47₁ and 47₂ connecting the support 32 to the send antenna 50 or 52 and a central branch 49 connecting the middles of the branches 47₁ and 47₂. This kind of arm is both very rigid and light in weight.

The heat exchanger powers are compared in order to compare the satellite according to the invention with a satellite that maintains a constant attitude relative to the Earth. That power conforms to the following equation:

Sin(23.5°).C_{S}.α.Sᵣ+Pᵣ=σε.Sᵣ.(Tᵣ⁴−4°⁴)

In the above equation, C_{S} is the solar constant, α the absorptivity of the coating of the heat exchanger on the North and South walls, Sᵣ the surface area of the heat exchanger, i.e. the surface area of the North or South wall, Pᵣ the power dissipated by the heat exchanger, σ Boltzmann's constant, ε the emissivity of the coating of the heat exchanger and Tᵣ the temperature of the heat exchanger.

The above formula yields the table below in which the situations at the summer and winter solstices are indicated, with the start of the life of the satellite and the end of the life of the satellite indicated in each case. When the satellite is equipped with quartz reflectors (denoted OSR in the table), the parameter α decreases as the age of the satellite increases.

| | |
|---|---|
| Summer solstice C_{S} in W | Winter solstice C_{S} in W |

| | 1320 | 1320 | | 1420 | 1420 | | |
|---|---|---|---|---|---|---|---|
| | start of life | end of life | | start of life | end of life | | |
| α OSR | 0.1 | 0.25 | | 0.1 | 0.25 | | |
| ε OSR | 0.83 | 0.83 | | 0.83 | 0.83 | | |
| ε white paint | 0.9 | 0.9 | | 0.9 | 0.9 | | |
| σ | 5.67E-08 | 5.67E-08 | | 5.67E-08 | 5.67E-08 | | |
| sink temperature | 4 | 4 | ° K | 4 | 4 | ° K | |
| panel temperature | 318.5 | 318.5 | ° K | 318.5 | 318.5 | ° K | 45 |
| solstice angle | 23.5 | 23.5 | | 23.5 | 23.5 | | |
| sine of angle | 0.398749069 | 0.398749069 | | 0.398749069 | 0.398749069 | | |
| OSR pwr dissipable/m² at 23.5° | 431.65 | 352.70 | | 427.66 | 342.73 | | |
| paint pwr dissipable/m² at 0° | 525.13 | 525.13 | | 525.13 | 525.13 | | |
| power saving (%) | 21.66 | 48.89 | | 22.79 | 53.22 | | |

In the above table, “sink temperature” means the temperature of space.

Thus it can be seen that the power saving can be more than 53%.

FIG. 7 is a diagram comparing the temperature variations of the South wall over several years for a satellite according to the invention and a conventional satellite. In the diagram, time (in years) is plotted on the abscissa axis and temperature (in ° C.) is plotted on the ordinate axis. The curve 60 represents the temperature variations for a conventional satellite. For a conventional satellite the temperature of the South wall varies seasonally. Accordingly, every year, the temperature has a maximum 62 at the winter solstice and minima 64 and 66 at the equinoxes. Note also that the maxima increase year by year because of aging of the equipment and the OSR.

FIG. 7a reproduces the area 66 of the curve 60 to a larger scale and shows that daily variations are superimposed on the seasonal variations.

Accordingly, to build a conventional satellite, equipment must be used that can withstand minimum and maximum temperatures respectively corresponding to the bottom curve 70 and the top curve 72 of the FIG. 7 diagram.

In that diagram, the straight line segment 74 represents the temperature of the South wall for a first embodiment of the invention and the straight line segment 76 that for a second embodiment of the invention. Given that the temperature variations are negligible, the equipment constraints are much less severe. The electronic components in particular can therefore be less costly or, for the same cost, more reliable.

If an average temperature of the order of 50° C. is chosen for the South wall (straight line segment 74), the power capacity is at a maximum. If an average temperature of the order of 20° C. is chosen (straight line segment 76), the equipment on board the satellite can be more conventional in design and therefore less costly.

This design temperature can also be used for electronics requiring colder thermal control (noise factor reduction, for example).

In the embodiment of the invention shown in FIGS. 8 and 9 the satellite has two parts, namely a platform unit 90 that includes only the control means, in particular the electronics necessary for the satellite to operate, and a unit 92 comprising the payload, i.e. the send and receive electronics. Accordingly, in this embodiment, the satellite has a modular structure in which the functions of the satellite itself have been separated from those of the telecommunication electronics. Under these conditions, satellites of this type can be produced at low cost because the platform 90 can be identical for a series of satellites, only the telecommunication unit 92 changing from one satellite to another.

Also, in this embodiment, the unit 92 is fixed to the support for the antennas 94. This means that it is not necessary to provide any flexible connection between the telecommunication control electronics and the antennas, such as are required in the first embodiment described above.

The platform unit 90 includes, in addition to the control electronic equipment of the satellite itself, the solar generators 96 and 98 shown folded in FIG. 8, fastened to the South wall 100 and the North wall 102. The function of a central tube 104 is to transmit dynamic loads associated with launch.

The payload equipment is no longer fixed directly to the North and South walls and so a multishelf device can be used to increase integration density. Thermal exchange between heat-dissipating equipment on shelves in the unit 92 and the North/South heat exchangers 100 and 102 is obtained by means of a fluid loop.

The set of antennas includes send sources 110, 112 (FIG. 9), receive sources 114, 116, and arms 118, 120 for the antenna reflectors. FIG. 9 shows the arms in the folded position.

1. A geosynchronous satellite including antenna means for communicating with an area of the terrestrial surface, characterized in that it includes attitude control means whereby North (24) and South (26) walls of the satellite are at all times parallel to the solar radiation (28′), and adjustment means so that the antenna means are always pointed toward the terrestrial coverage area.

2. The satellite according to claim 1 characterized in that it includes solar panels (30) perpendicular to the solar radiation whose surface is fastened to the body of the satellite.

3. The satellite according to claim 1 characterized in that it includes a support (32) for all the antenna means that can be oriented relative to the body (22) of the satellite including the North and South walls.

4. The satellite according to claim 3 characterized in that telecommunication electronics means (92) are fastened to the support for the antenna means.

5. The satellite according to claim 4 characterized in that the attitude control means and the support adjustment means are fastened to the body of the satellite.

6. The satellite according to claim 1 characterized in that the adjustment means for maintaining the antenna means pointed at all times toward the coverage area include electronic scanning means (32′).

7. The satellite according to claim 1 characterized in that the adjustment means for maintaining the antenna means directed at all times toward the terrestrial coverage area are also used for pointing corrections and/or to modify the position of the coverage area.

8. The satellite according to claim 1 characterized in that the North and/or South walls are covered with white paint.

9. The satellite according to claim 1 characterized in that output multiplexers are disposed on an outside face and preferably associated with radiant thermal control by direct exposure to space.

10. The satellite according to claim 3 characterized in that the antenna means include reflectors (50, 52) connected to the support (32) by carbon arms (46, 48).

11. The satellite according to claim 10 characterized in that the carbon arms (46, 48) are generally H-shaped.

12. A method of assembling a geosynchronous satellite according to claim 3 characterized in that the support with the antenna means is constructed separately from the body of the satellite.
